(19) United States
(12) Patent Application Publication
(10) Pub. No.: US 2006/0146023 A1
(43) Pub. Date: Jul. 6, 2006

(54) Mobile computer mouse

(76) Inventors: Oren Kidron, Moshav Mishmeret (IL); Moshe Meyassed, Kadima (IL)

Correspondence Address: BROWDY AND NEIMARK, P.L.L.C.;624 NINTH STREET, NW, SUITE 300, WASHINGTON, DC, 20001-5303, US

(21) Appl. No.: 11/028,226

(22) Filed: Jan. 4, 2005

(51) Int. Cl. G09G 5/08

(52) U.S. Cl. 345/163

(57) ABSTRACT

A computer mouse having a unique identification that uniquely identifies the computer mouse and is readable by a computer to which the mouse is coupled. The computer mouse is provided with a processor, a memory and a mouse interface and may be used for controlling data transfer between the mouse and a computer to which it is coupled, by receiving from the computer a data transfer request and using the mouse interface to authorize the data transfer request. The mouse may be used to provide personal and secure control of an application that is distributed between the mouse and the computer so as to allow use of the mouse to control a software application running on the computer and at the same time to allow the computer to control the behavior of the mouse by interacting with software run thereby.

### FIELD OF THE INVENTION

This invention relates to a computer mouse.

### BACKGROUND OF THE INVENTION

The use of a computer mouse to control a computer is well known. The mouse may be coupled to the computer via a wire of wirelessly, and includes a mouse interface typically comprising a position sensor for sensing position of the mouse and a pair of selection buttons. Known computer mice are largely interchangeable so that they can easily be used with different computers, virtually without restriction. Modern operating systems such as Microsoft® Windows are adapted to recognize hardware devices that are connected to the computer and are not currently configured for use. Microsoft is a registered trademark of Microsoft Corporate, Redmond, USA. To this end, hardware devices are encoded so that all hardware devices of the identical type have an identical type code. On booting up, the operating system checks that all connected devices are configured. If a hardware device, such as a computer mouse, that is not currently configured is coupled to the computer's motherboard, the device is recognized by the operating system and its driver is configured for use therewith.

It thus transpires that computer mice are encoded for identifying a mouse type so as to allow automatic configuration when a new mouse type is connected to a computer.

It is also known in the art to personalize computer mice so as to enhance their security. For example, US 2004/0080492A1 (Chen) entitled “Fingerprint access control mouse” and published Apr. 29, 2004 discloses a fingerprint access control mouse used as a data input and pointing device in a personal computer (PC). The mouse has a lens in the outside wall and an integral image pickup device such as a CCD camera adapted to pick up the image of the fingerprint of the finger of the user imaged by the lens. The user's fingerprint is thereby scanned and may be used to allow use of the mouse with authorized personal only.

Although the CCD camera is located within the mouse itself, it appears that the scanned fingerprint data is transferred for processing to the computer, where in effect it is compared with pre-configured files containing fingerprint data of authorized users.

However, there is no suggestion in the art to provide memory within a computer mouse and to customize the mouse for controlling data transfer between the mouse and a computer coupled thereto.

Moreover, there appears to be no suggestion to store a unique identification within the mouse itself for uniquely identifying the computer mouse as opposed to a mouse type, which is of course common to many computer mice and is therefore not able to identify a specific mouse.

### SUMMARY OF THE INVENTION

It is therefore a principal object of the invention to provide a computer mouse for controlling data transfer between the mouse and a computer coupled thereto.

It is a further object of the invention to provide a computer mouse having a unique identification for uniquely identifying the computer mouse.

These objects are realized in accordance with a first aspect of the invention by a method for controlling data transfer between a computer and a computer mouse coupled thereto, the mouse having a processor, a memory and a mouse interface, the method comprising:

receiving from the computer a data transfer request; and

using the mouse interface to authorize the data transfer request.

According to a second aspect of the invention there is provided a computer mouse, comprising a unique identification uniquely identifying the computer mouse and being readable by a computer to which the mouse is coupled.

Typically, such a mouse comprises a non-volatile memory for allowing data transfer between the non-volatile memory and the computer during a session. In such cases the non-volatile memory allows data to be transferred thereto from a computer to which the mouse is coupled and for the data to be transferred to the same or a different computer in a subsequent session. The unique identification may be stored in a read only memory within the mouse.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing the functionality of a computer mouse according to the invention;

FIG. 2 is a pictorial view of a computer mouse according to the invention;

FIGS. 3 and 4 are flow charts showing the principal actions carried out by a mouse processor according to different embodiments of the invention; and

FIG. 5 is a flow chart showing the principal actions carried out by a computer coupled to the mouse for authenticating the mouse and setting up permissions.

### DETAILED DESCRIPTION OF EXEMPLARY EMBODIMENTS

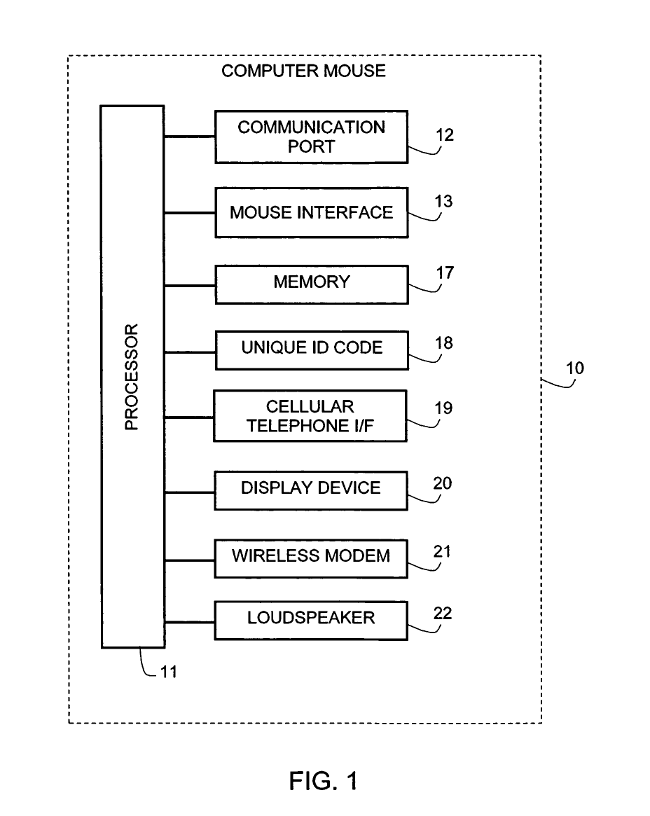

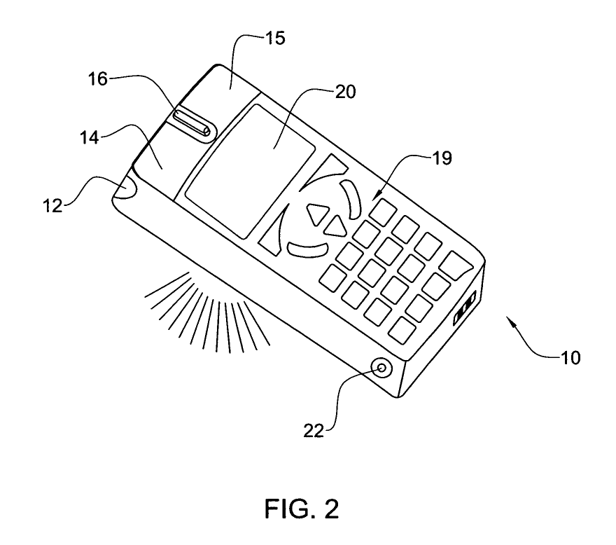

FIG. 1 is a block diagram showing the functionality of a computer mouse 10 shown pictorially in FIG. 2. The mouse 10 comprises a processor 11 having a communication port 12 for coupling the mouse to a host computer (not shown) and a mouse interface 13, typically comprising left and right mouse buttons 14 and 15 respectively and a trackball 16. A memory 17 is coupled to the processor 11 and stores a unique identification 18 that uniquely identifies the mouse and is readable by the computer to which the mouse is coupled. The memory 17 may comprise a read only memory (ROM) for storing the unique identification 18 as well as a non-volatile read/write memory for storing data to be transferred to or from the computer. Optionally, there may be further coupled to the processor 11 a cellular telephone interface 19 (constituting a mobile telephone interface) and a display device 20. The communication port 12 may be constituted by a wireless modem 21 shown as a separate component in the figure; or it may be a WAP, IR or Bluetooth interface for allowing wireless communication with the computer. A loudspeaker 22 may also be coupled to the processor 11 for producing an audible signal to alert a user of the mouse when action is required.

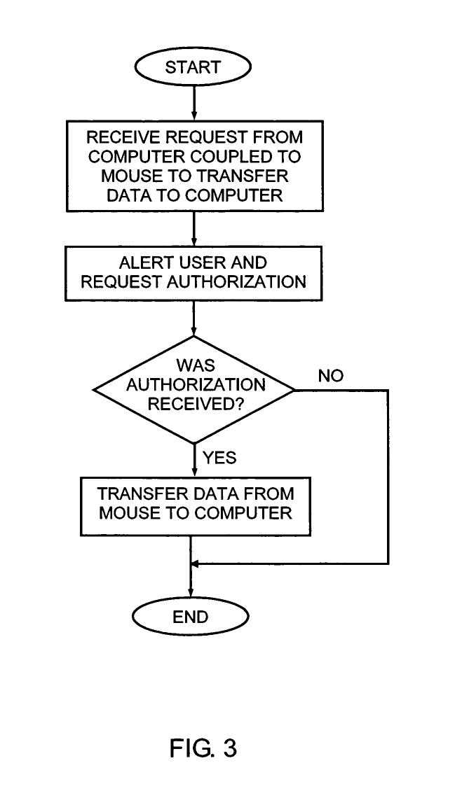

The mouse 10 may be used, by way of non-limiting example, to transfer data securely between the non-volatile memory and the computer during a session as will now be explained with reference to FIGS. 2 and 3.

Thus, FIG. 3 is a flow chart showing the principal actions carried out by the processor 11 in the mouse 10 when transferring data from the non-volatile memory 17 to the computer. This may be necessary, for example, to supply credit card information to a secure application program running on the computer. At a certain point in the program, the secure application needs the user's credit card number. In typical known scenarios the user would enter this manually using the keyboard. Thus, the only security barrier is the accuracy of the number as entered by the user and, as is well known, once this information has found its way into the wrong hands, it is easy for someone to enter it fraudulently in order to purchase goods and services on-line. In the invention, such possibility is avoided since the credit card number is stored in the non-volatile memory 17 of the mouse and is transferred to the computer only when prompted by the computer to enter it. Thus, the mouse 10 serves not only as a repository for storing secure data but, since it is uniquely identifiable, it serves also to identify the rightful owner and prevents the possibility of fraud. In use, the application program may prompt the user to enter the required information. This may be done by alerting the user whenever data is to be transferred such as, for example, by issuing an audible prompt via the loudspeaker 22. Additionally, the information which is about to be transferred from the non-volatile memory 17 of the mouse may be displayed on the display device 20 so that the user is clear what information is going to be transferred prior to authorizing the transfer using the mouse interface 13. This prevents data being transferred to a software application running on the host computer without the complete awareness and agreement of the user and helps to prevent unscrupulous vendors from providing software applications that masquerade as bona fide programs for the purpose of intercepting secret data, such as credit card details, and then using this data fraudulently.

In many cases, it may be desirable to store different information in the non-volatile memory 17 of the mouse such as the owner's name, address and other data that may be required to transfer to the same or different application software running on the host computer. Here also, it may be preferable to prompt the user to enter the required information and possibly also to identify which information is now required. According to the invention, this may be done by alerting the user whenever data is to be transferred such as, for example, by issuing an audible prompt via the loudspeaker 22. However, since there are different data stored in the non-volatile memory 17 of the mouse, it is now necessary to prompt the user to enter a specific data item and allow the user to select the required item. To this end, the mouse processor 11 can be programmed to operate in conjunction with the mouse interface 13 to allow the user to scroll through the stored and to display the stored data for user selection and transfer to the host computer.

Preferably, the application software on the host computer is adapted to run in a symbiotic relationship with software running on the mouse 10 under control of the mouse processor 11. For example, when the application software needs the user to enter his credit card number, the computer may display “enter credit card number” or it may instruct the loudspeaker 22 in the mouse to prompt the user by vocalizing a similar message. The user now uses the mouse interface 13 as explained above to select and display the relevant data and transfer it to the computer. Thus, at all times the user is fully informed of the exact nature of any data that is being transferred and the mouse 10 serves both to control the application software while serving as a highly effective security barrier.

Of course, it is known to use external hardware such as smart cards as repositories for storing secure data and to transfer (i.e. “copy”) such data to a host computer to which the smart card is coupled by either a contact or contactless interface. However, in such applications the smart card serves as no more than a secure and personalized repository. It does not have a symbiotic relationship with the computer such that it interacts with application software that runs on the computer and alerts the user so as to inform the user of what data is required prior to effecting the required transfer. Nor does it allow the computer to interact with software running on the mouse processor so as to display or otherwise inform the user of actual data that is to be transferred so as to restore full control to the user. In summary, smart cards acts simply as a data storage medium allowing “blind” data transfer to a host computer that is in communication with the smart card. As against this, the personal mouse 10 according to the invention allows the user to use the mouse to control a software application running on a host computer that is in communication with the mouse (in known manner) and at the same time to allow the host computer to control the behavior of the mouse by interacting with software run thereby (which has not been suggested in the art).

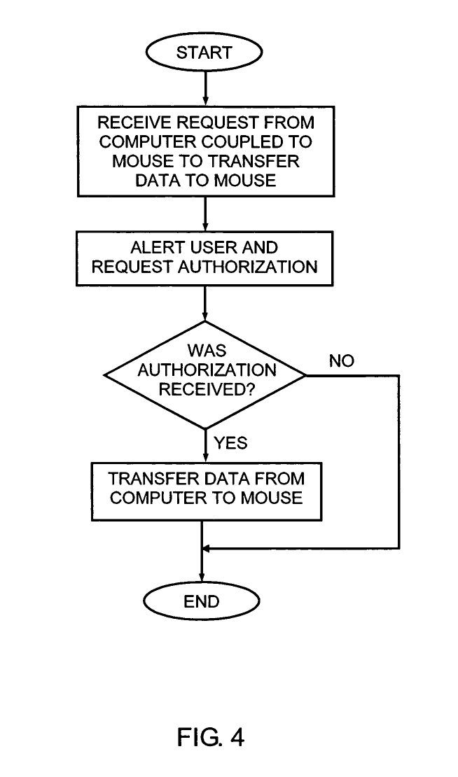

FIG. 4 is a flow chart showing the principal actions carried out by the processor 11 in the mouse 10 when transferring data from a computer to the non-volatile memory 17. Since the principle of operation is similar to that described above with reference to FIG. 3, and so will not be repeated in detail. Here also, any transfer of data is alerted to the user prior to its being transferred so as to allow the user to use the mouse to control a software application running on a host computer that is in communication with the mouse and at the same time to allow the host computer to control the behavior of the mouse by interacting with software run thereby.

The communication port 12 allows for bi-directional communication between the mouse 10 and the host computer using any suitable technology. Thus, it may include connecting wires for connection to a mouse port of the computer or it may include an optical communication port, such as infrared or it may allow for short range communication using RF, WAP, Bluetooth or any other suitable protocol all of which are well known per se. Thus, it is to be understood that FIG. 1 shows the communication port 12 schematically and the wireless modem 21, if provided, may itself constitute the communication port 12 or it may be in addition thereto. Likewise, infrared, RF, WAP and Bluetooth interfaces may be provided as required.

The mouse may also be provided with cellular telephone interface 19 so as to allow its use as a cellular telephone. In such case, the cellular telephone interface 19 may operate in conjunction with the mouse interface 13 so that, when being used to transfer data between the mouse and a host computer, for example, the cellular telephone interface 19 augments the mouse interface 13 and provides complementary features. For example, the scroll keys of the cellular telephone interface 19 may allow for scrolling of data stored in the non-volatile memory 17 of the mouse, thus obviating the need for a scrolling control in the mouse interface 13, even though this is very commonly provided as standard in the form of a wheel that can be rotated in forward and reverse directions.

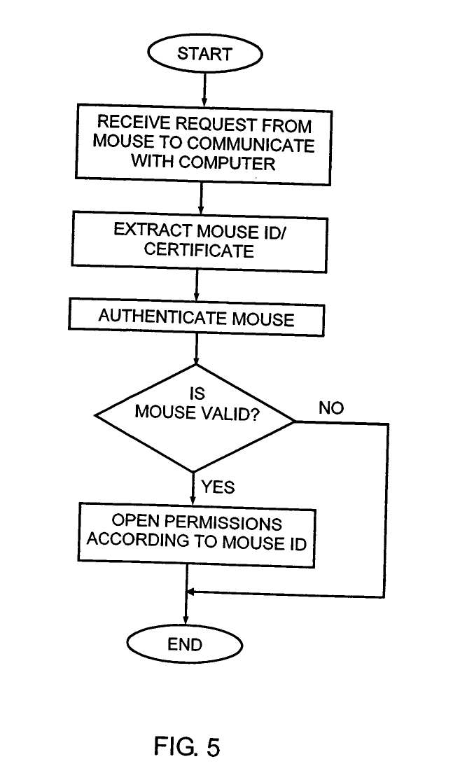

FIG. 5 is a flow chart showing the principal actions carried out by the computer for authenticating the mouse and setting up permissions. Thus, on receiving a request from the mouse to communicate with the computer, the computer extracts the mouse ID or certificate and authenticates the mouse. If the mouse is valid, the computer opens pre-established permissions according to the mouse ID.

As noted above, the mouse ID is stored in ROM within the mouse. The certificate may also be stored in memory in the manner that Secure Socket Layer (SSL) certificates may be stored in a web server for securing web sites. Alternatively, the certificate may be a document similar to a passport having a unique code that is supplied with the mouse and identifies it. Such an ID may be entered manually to the computer either via the computer keyboard or the cellular telephone interface 19, when provided. To this end, the mouse interface 13 may also be provided with a keyboard so as to allow the entry of alphanumeric data, even when the mouse 10 is provided without a cellular telephone interface.

The cellular telephone interface 19, when provided, may be integral with the mouse 10 as shown in FIG. 2. Alternatively, the mouse may be adapted to be coupled to a cellular telephone such that the mouse and the cellular telephone interface are separate components. In such case, the unique identification may be the unique identity of the cellular telephone itself which is then associated with the mouse when the mouse is coupled to the cellular telephone. Suitable connection may be via the communication port 12 of the mouse, which may be coupled to the cellular telephone via a wireless or wired interface such as are commonly provided as standard.

It will be clear that many modifications will be apparent to those skilled in the art without departing from the scope of the invention as defined in the claims. Likewise, although a particular application has been described with regard to the transfer of secure data from the mouse to the computer or from the computer to the mouse for storage in the non-volatile memory 17 thereof, it will be understood that this is by way of non-limiting example only. Thus, the invention is suitable for any application that may be distributed between the mouse and the computer so as to allow use of the mouse to control a software application running on the computer and at the same time to allow the computer to control the behavior of the mouse by interacting with software run thereby.

It should also be noted that although the preferred embodiment relates to connection of a cellular telephone interface to the mouse, any other mobile telephone may be employed. For example, the mobile telephone interface may be realized by a cordless telephone, satellite telephone etc.

It will also be understood that the data stored in the mouse or the computer may be encoded prior to effecting data transfer between the mouse and the computer using a key conveyed by the computer to the mouse. The mouse ID may be likewise encoded prior to conveying to the computer.

It will also be understood that the invention contemplates a computer program being readable by a computer for executing the method of the invention. The invention further contemplates a machine-readable memory tangibly embodying a program of instructions executable by the machine for executing the method of the invention.

1. A method for controlling data transfer between a computer and a computer mouse coupled thereto, the mouse having a processor, a memory and a mouse interface, the method comprising:
receiving from the computer a data transfer request; and
using the mouse interface to authorize the data transfer request.

2. The method according to claim 1, wherein the data transfer request relates to data that is stored in the memory of the mouse and is to be conveyed to the computer.

3. The method according to claim 1, wherein the data transfer request relates to data that is stored in the computer and is to be conveyed to the mouse for storage in the memory thereof.

4. The method according to claim 2, wherein the computer is adapted to open pre-established permissions according to the mouse ID.

5. The method according to claim 2, further comprising alerting a user of the mouse regarding said data and requesting authorization prior to effecting said data transfer.

6. The method according to claim 5, wherein said data is displayed on a display panel of the mouse.

7. The method according to claim 6, wherein said data is vocalized by a loudspeaker connected to the mouse.

8. The method according to claim 7, wherein the loudspeaker is wirelessly connected to the mouse.

9. The method according to claim 1, further including encoding said data prior to effecting said data transfer using a key conveyed by the computer to the mouse.

10. A computer mouse, comprising a unique identification uniquely identifying the computer mouse and being readable by a computer to which the mouse is coupled.

11. The computer mouse according to claim 10, further comprising a non-volatile memory for allowing data transfer between the non-volatile memory and the computer during a session.

12. The computer mouse according to claim 11, further comprising:
a processor,
a user interface coupled to the processor, and
a display device coupled to the processor.

13. The computer mouse according to claim 11, further comprising a wireless modem.

14. The computer mouse according to claim 10, further comprising a mobile telephone interface.

15. The computer mouse according to claim 14, wherein the mobile telephone interface is integral with the mouse.

16. The computer mouse according to claim 14, wherein mouse is adapted to be coupled to the mobile telephone interface.

17. The computer mouse according to claim 16, wherein the unique identification is stored in the mobile telephone interface so as to be associated with the mouse when the mouse is coupled to the mobile telephone interface.

18. A program storage device readable by machine, tangibly embodying a program of instructions executable by the machine to perform a method for controlling data transfer between a computer and a computer mouse coupled thereto, the mouse having a processor, a memory and a mouse interface, the method comprising:
conveying a data transfer request to the mouse and/or receiving a data transfer request from the mouse;
receiving a unique identity identifying the mouse;
authorizing the data transfer request.

19. A computer program product comprising a computer useable medium having computer readable program code embodied therein for controlling data transfer between a computer and a computer mouse coupled thereto, the mouse having a processor, a memory and a mouse interface, the computer program product comprising:
computer readable program code for causing the computer to convey a data transfer request to the mouse and/or to receive a data transfer request from the mouse,
computer readable program code for causing the computer to receive a unique identity identifying the mouse, and
computer readable program code for causing the computer to use the mouse interface to authorize the data transfer request.
